(19) United States
(12) Patent Application Publication
(10) Pub. No.: US 2021/0325622 A1
(43) Pub. Date: Oct. 21, 2021

(54) OPTICAL SIGNAL PROCESSING DEVICE

(71) Applicant: EZCONN CORPORATION, New Taipei City (TW)

(72) Inventor: KUEI HSIANG CHENG, New Taipei City (TW)

(21) Appl. No.: 17/231,053

(22) Filed: Apr. 15, 2021

(30) Foreign Application Priority Data
Apr. 15, 2020 (TW) 109204417

(51) Int. Cl. G02B 6/44

(52) U.S. Cl. CPC G02B 6/4452; G02B 6/443; G02B 6/4471

(57) ABSTRACT

An optical signal processing device includes a case, two sets of first external signal transmission modules, two sets of first internal signal transmission modules, a first optical signal processor, and a plurality of first tubes. Each of the first external signal transmission modules includes a first external signal input channel and a first external signal output channel. Each of the first internal signal transmission modules includes a first internal signal input channel and a first internal signal output channel. The first optical signal processor includes a first inlet connector, a first outlet connector, four first bare optical fibers and four second bare optical fibers. The first bare optical fibers and the second bare optical fibers are sleeved via the first tubes. The design for the first tube can improve the impact resistance and bending degree of the optical fiber.

### RELATED APPLICATIONS

This application claims priority to TW Application Ser. No. 109204417, filed on Apr. 15, 2020, which is incorporated herein by reference in its entirety.

### TECHNICAL FIELD

Example embodiments relate generally to the field of optical device and, more particularly, to mechanical structures for providing tensile strength and external protection in a closed space.

### BACKGROUND

Due to the limitation of the process technology, it is hard for an optical signal processing device to arrange multiple coating optical fibers to a connector of an optical signal processor in a closed space. Thus, bare optical fibers are exerted to connect the optical signal processor via the components inside the case.

During the installation process, as the distance between the bare optical fiber and the component is short, optical losses would be severe due to the large angle bending with a smaller radius of curvature. Therefore, to reduce the optical losses as bending the bare optical fiber, the bare optical fiber installed in a closed case will be winded in a manner with a longer path. To avoid breakage of the bare fiber, additional attention must be paid during installation. However, even if the installation is completed smoothly and successfully, the bare optical fiber is still got damaged quite often due to external forces, such as vibration or shaking, during the transportation process.

### SUMMARY

An optical signal processing device is provided in the present invention.

In an embodiment, an optical signal processing device comprises a case, two first external signal transmission modules, two first internal signal transmission modules, a first optical signal processor, four first bare optical fibers, four second bare optical fibers, a plurality of first tubes and a cover. The case has an accommodating space. The two first external signal transmission modules are partially located inside the accommodating space, wherein each of the first external signal transmission modules include a first external signal input channel and a first external signal output channel. The two first internal signal transmission modules are located in the accommodating space, wherein each of the first internal signal transmission modules includes a first internal signal input channel and a first internal signal output channel. The first optical signal processor located in the accommodating space includes a first inlet connector and a first outlet connector. The first bare optical fibers are connected to the first inlet connector. Two of the first bare optical fibers are connected to the first external signal input channels, and the other two of the first bare optical fibers are connected to the first internal signal input channels. The second bare optical fibers are connected to the first outlet connector. Two of the second bare optical fibers are connected to the first external signal output channels, and the other two of the second bare optical fibers are connected to the first internal signal output channels. The first tubes are sleeved on the first bare optical fibers and the second bare optical fibers. The cover closes the accommodating space of the case.

In some embodiments, the optical signal processing device further comprises a plurality of first limiting elements located in the accommodating space. Each of the first limiting elements forms an opening and the first tubes pass through the openings of the corresponding first limiting elements, whereby the first tubes are collected inside the first limiting elements.

In some embodiments, the first limiting elements are arranged along an edge of the case.

In some embodiments, a first gap is located between an outer peripheral wall of the first bare optical fiber and an inner peripheral wall of the corresponding first tube; the first gap is also located between an outer peripheral wall of the second bare optical fiber and an inner peripheral wall of the corresponding first tube.

In some embodiments, the ratio of the radius of each of the first bare optical fibers to the corresponding first gap in the radial direction is ranging from 5 to 1, and the ratio of the radius of each of the second bare optical fibers to the corresponding first gap in the radial direction is ranging from 5 to 1.

In some embodiments, an outer diameter of the first bare optical fiber is the same as the second bare optical fiber.

In some embodiments, the outer diameter of the first bare optical fiber is 0.25 mm; an inner diameter and an outer diameter of the first tube are 0.3 mm and 0.4 mm respectively.

In some embodiments, the optical signal processing device further comprises two second external signal transmission modules, two second internal signal transmission modules, a second optical signal processor, four third bare optical fibers, four fourth bare optical fibers and a plurality of second tubes. The two second external signal transmission modules are partially located in the accommodating space. Each of the two second external signal transmission modules includes a second external signal input channel and a second external signal output channel. The two second internal signal transmission modules are located in the accommodating space, each of the two second internal signal transmission modules includes a second internal signal input channel and a second internal signal output channel. The second optical signal processor located in the accommodating space includes a second inlet connector and a second outlet connector. The third bare optical fibers are connected to the second inlet connector. The two of the third bare optical fibers are connected to the second external signal input channels, and the other two of the third bare optical fibers are connected to the second internal signal input channels. The fourth bare optical fibers are connected to the second outlet connector. The two of the fourth bare optical fibers are connected to the second external signal output channels, and the other two of the fourth bare optical fibers are connected to the second internal signal output channels. The second tubes are sleeved on the third bare optical fibers and the fourth bare optical fibers.

In some embodiments, the first optical signal processor, the second optical signal processor and a wire channel are correspondingly disposed in the case, the first optical signal processor and the second optical signal processor are adjacent to each other and the wire channel is adjacent to the first optical signal processor and the second optical signal processor. The wire channel is used to accommodate the corresponding first tubes and the second tubes.

In some embodiments, the first inlet connector of the first optical signal processor is between the wire channel and the first external signal transmission modules. Each of the first bare optical fibers connected to the first external signal transmission modules has a connecting line segment and each of the second bare optical fibers connected to the first external signal transmission modules has a connecting line segment. The connecting line segments are disposed away from the first inlet connector.

In some embodiments, the two first external signal transmission modules are adjacent to the two second external signal transmission modules in one side of the case; the two first internal signal transmission modules are adjacent to the two second internal signal transmission modules in the other side of the case. The first optical signal processor and the second optical signal processor are adjacent.

In some embodiments, the two first external signal transmission modules and the two first internal signal transmission modules are disposed opposite to each other; the two second external signal transmission modules and the two second internal signal transmission modules are disposed opposite to each other. That is, the first optical signal processor is between the first external signal transmission module and the corresponding first internal signal transmission module; the second optical signal processor is between the second external signal transmission module and the corresponding second internal transmission module.

In some embodiments, the optical signal processing device further comprises a plurality of second limiting elements located in the accommodating space. Each of the second limiting elements forms an opening, the second tubes pass through the openings of the corresponding second limiting elements, whereby the second tubes are collected inside the second limiting elements.

In some embodiments, an outer peripheral wall of the third bare optical fiber and an outer peripheral wall of the fourth bare optical fiber each have a second gap with an inner peripheral wall of the corresponding second tube.

In some embodiments, the ratio of the radius of each of the third bare optical fibers to the corresponding second gap in the radial direction is ranging from 5 to 1, and the ratio of the radius of each of the fourth bare optical fibers to the corresponding second gap in the radial direction is ranging from 5 to 1.

In some embodiments, an outer diameter of the third bare optical fiber is the same as the fourth bare optical fiber.

In some embodiments, the outer diameter of the third bare optical fiber is 0.25 mm; an inner diameter and an outer diameter of the second tube are 0.3 mm and 0.4 mm respectively.

In an embodiment, an optical signal processing device comprises a case, two first external signal transmission modules, two first internal signal transmission modules, a first optical signal processor, four first bare optical fibers, four second bare optical fibers, a plurality of first tubes and a cover. The case has an accommodating space. The two first external signal transmission modules are partially located inside the accommodating space, wherein each of the first external signal transmission modules include a first external signal input channel and a first external signal output channel. The two first internal signal transmission modules are located in the accommodating space, wherein each of the first internal signal transmission modules includes a first internal signal input channel and a first internal signal output channel. The first optical signal processor located in the accommodating space includes a first inlet connector and a first outlet connector. The first bare optical fibers are connected to the first inlet connector. Two of the first bare optical fibers are individually connected to the first external signal input channel and the first external signal output channel, and the other two of the first bare optical fibers are individually connected to the first internal signal input channel and the first internal signal output channel. The second bare optical fibers are connected to the first outlet connector. Two of the second bare optical fibers are individually connected to the first external signal input channel and the first external signal output channel, and the other two of the second bare optical fibers are individually connected to the first internal signal input channel and the first internal signal output channels. The first tubes are sleeved on the first bare optical fibers and the second bare optical fibers. The cover closes the accommodating space of the case.

In some embodiment, the optical signal processing device further comprises a plurality of first limiting elements located in the accommodating space. Each of the first limiting elements forms an opening, and the first tubes pass through the openings of the corresponding first limiting elements, whereby the first tubes are collected inside the first limiting elements.

In some embodiment, the two first external signal transmission modules are between the first inlet connector of the first optical signal processor and the first limiting elements. Each of the first bare optical fibers and the second bare optical fibers has a connecting line segment correspondingly, and the connecting line segments of the first bare optical fibers and the second bare optical fibers are disposed away from the first inlet connector.

### BRIEF DESCRIPTION OF THE DRAWINGS

Unless specified otherwise, the accompanying drawings illustrate aspects of the innovative subject matter described herein. Referring to the drawings, wherein like reference numerals indicate similar parts throughout the several views, several examples of optical signal processing device incorporating aspects of the presently disclosed principles are illustrated by way of example, and not by way of limitation.

FIG. 1A is a schematic perspective view of an optical signal processing device, according to an example embodiment.

FIG. 1B is another schematic perspective view of the optical signal processing device of FIG. 1A.

FIG. 1C is a stereogram of the optical signal processing device of FIG. 1A without cover.

FIG. 1D is the schematic perspective top view of the optical signal processing device of FIG. 1A without cover.

FIG. 1E is a schematic cross-section view of a first tube sleeved on a first bare optical fiber, according to the example embodiment illustrated in FIG. 1.

FIG. 1F is a schematic cross-section view of a first tube sleeved on a second bare optical fiber, according to the example embodiment illustrated in FIG. 1A.

FIG. 2A is a schematic perspective view of an alternative optical signal processing device without a plurality of third bare optical fibers and fourth bare optical fibers, according to an example embodiment.

FIG. 2B is a schematic perspective second of the alternative optical signa process device of FIG. 2A.

FIG. 2C is a view similar to FIG. 2B showing a plurality of connecting line segments are disposed away from a first inlet connector.

FIG. 3 is a schematic perspective view of another alternative optical signal processing device, according to an example embodiment.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

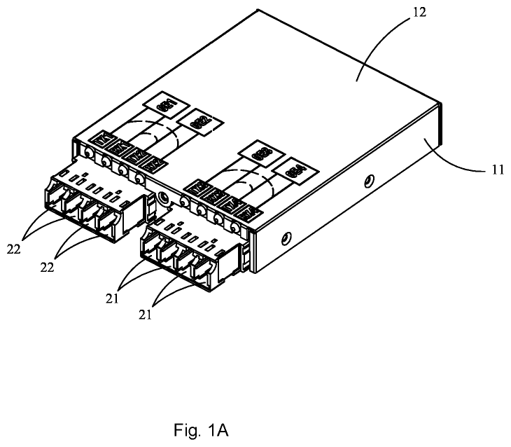

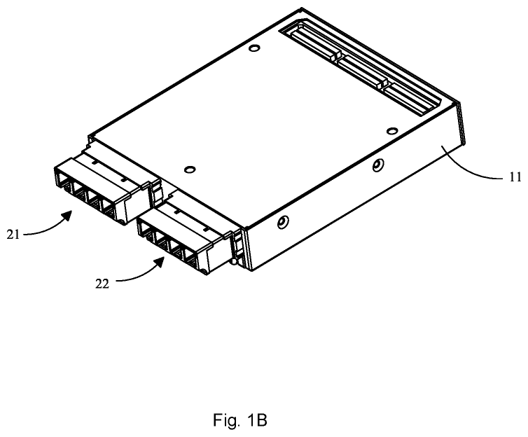

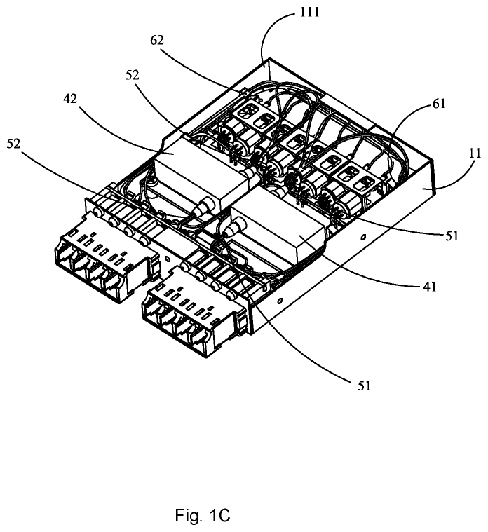

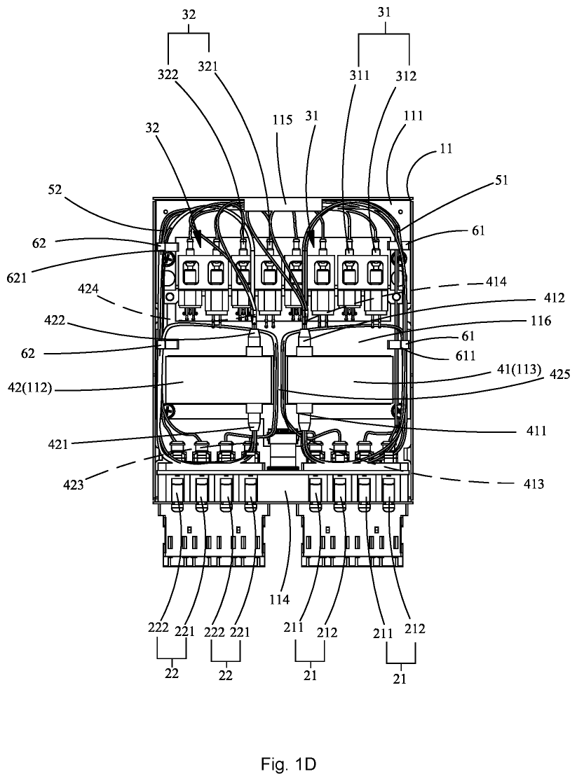

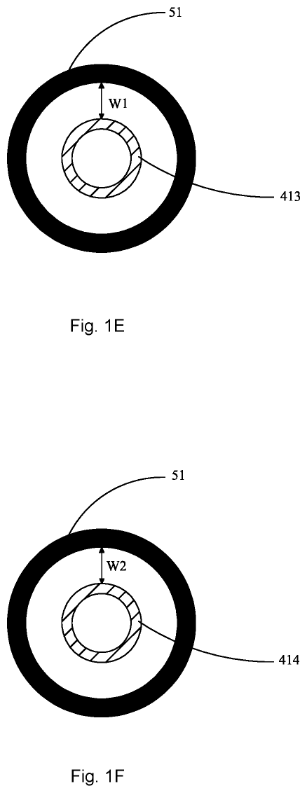

FIG. 1A is a schematic perspective first view of an optical signal processing device, according to an example embodiment. FIG. 1B is a schematic perspective second view of the optical signal processing device of FIG. 1A, according to an example embodiment. FIG. 1C is a schematic perspective third view of the optical signal processing device of FIG. 1A without cover, according to an example embodiment. FIG. 1D is a schematic perspective fourth view of the optical signal processing device of FIG. 1A without cover, according to an example embodiment. Referring to FIGS. 1A to 1D, in an embodiment, an optical signal processing device comprises a case 11, a cover 12, two sets of first external signal transmission modules 21, two sets of second external signal transmission modules 22, two sets of first internal signal transmission modules 31, two sets of second internal signal transmission modules 32, a first optical signal processor 41, a second optical signal processor 42, a plurality of first tubes 51, a plurality of second tubes 52, two first limiting elements 61, and two second limiting elements 62.

The case 11 has an accommodating space 111. The case 11 includes a left-side portion 112, a right-side portion 113, a front-side portion 114, a rear-side portion 115, and an intermediate portion 116 located between the front-side portion 114 and the rear-side portion 115. The cover 12 is used for covering the accommodating space 111 of the case 11.

The two sets of first external signal transmission modules 21 and the two sets of second external signal transmission modules 22 are partially located inside the accommodating space 111, and all the elements mentioned above are located on the front-side portion 114 of the case 11. Each of the two sets of first external signal transmission modules 21 includes a first external signal input channel 211 and a first external signal output channel 212. Each of the two sets of second external signal transmission modules 22 includes a second external signal input channel 221 and a second external signal output channel 222.

The two sets of first internal signal transmission modules 31 and the two sets of second internal signal transmission modules 32 are all located in the accommodating space 111, and all the elements mentioned above are located on the rear-side portion 115 of the case 11. Each of the two sets of first internal signal transmission modules 31 includes a first internal signal input channel 311 and a first internal signal output channel 312. Each of the two sets of second internal signal transmission modules 32 includes a second internal signal input channel 321 and a second internal signal output channel 322.

The first optical signal processor 41 and the second optical signal processor 42 are both located in the accommodating space 111, and both are located on the intermediate portion 116 of the case 11. The first optical signal processor 41 and the second optical signal processor 42, can be switches, filters or other components for processing optical signals according to actual needs.

The two sets of first external signal transmission modules 21 are adjacent to the two sets of second external signal transmission modules 22 in the front-side 114 of the case 11; the two sets of first internal signal transmission modules 31 are adjacent to the two sets of second internal signal transmission modules 32 in the rear-side 115 of the case 11. The two sets of first external signal transmission modules 21 and the two sets of first internal signal transmission modules 31 are disposed opposite to each other; the two sets of second external signal transmission modules 22 and the two sets of second internal signal transmission modules 32 are disposed opposite to each other. The first optical signal processor 41 and the second optical signal processor 42 are adjacent. The first optical signal processor 41 is between the set of first external signal transmission module 21 and the corresponding set of first internal signal transmission module 31; the second optical signal processor 42 is between the set of second external signal transmission module 22 and the corresponding set of second internal transmission module 32.

More specifically, the first optical signal processor 41 is located on the right-side portion 113 of the case 11 and includes a first inlet connector 411, a first outlet connector 412, four first bare optical fibers 413 connected to the first inlet connector 411, and four second bare optical fibers 414 connected to the first outlet connector 412. Two of the first bare optical fibers 413 are connected to the first external signal input channel 211, the other two of the first bare optical fibers 413 are connected to the first internal signal input channel 311. Two of the second bare optical fibers 414 are connected to the first external signal output channel 212, the other two of the second bare optical fibers 414 are connected to the first internal signal output channel 312.

The second optical signal processor 42 is located on the left-side portion 112 of the case 11 and includes a second inlet connector 421, a second outlet connector 422, four third bare optical fibers 423 connected to the second inlet connector 421, and four fourth bare optical fibers 424 connected to the second outlet connector 422. Two of the third bare optical fibers 423 are connected to the second external signal input channel 221; the other two of the third bare optical fibers 423 are connected to the second internal signal input channel 321. Two of the fourth bare optical fibers 424 are connected to the second external signal output channel 222; the other two of the fourth bare optical fibers 424 are connected to the second internal signal output channel 322. In this embodiment, the first optical signal processor 41, the second optical signal processor 42 and a wire channel 425 are correspondingly disposed in the case 11. The first optical signal processor 41 and the second optical signal processor 42 are adjacent to each other. The wire channel 425 is adjacent to the first optical signal processor 41 and the second optical signal processor 42.

FIG. 1D is a schematic perspective fourth view of the optical signal processing device of FIG. 1A without cover, according to an example embodiment. FIG. 1E is a schematic cross-section view of a first tube sleeved on a first bare optical fiber, according to an example embodiment. FIG. 1F is a schematic cross-section view of a first tube sleeved on a second bare optical fiber, according to an example embodiment. Referring to FIGS. 1D to 1F, in this embodiment, the first tubes 51 sleeved on the first bare optical fibers 413 and the second bare optical fibers 414. A first gap W1 is located between an outer peripheral wall of the first bare optical fiber 413 and an inner peripheral wall of the corresponding first tube 51; a first gap W2 is located between the second bare optical fiber 414 and an inner peripheral wall of the corresponding first tube 51. The ratio of the radius of each first bare optical fiber 413 to the corresponding first gap W1 in the radial direction is ranging from 5 to 1, and the ratio of the radius of each second bare optical fiber 414 to the corresponding first gap W2 in the radial direction is ranging from 5 to 1. For example, as an outer diameter of the first bare optical fiber 413 is 0.25 mm, which is the same as the second bare optical fiber 414, the inner diameter of the first tube 51 can be 0.3 mm, and the outer diameter of the first tube 51 can be 0.4 mm. In some embodiments, the inner diameter of the tube varies with the different bare optical fibers' diameter such as 0.4mm, 0.45 mm, 0.5 mm, or 0.6 mm.

The second tubes 52 sleeved on the third bare optical fibers 423 and the fourth bare optical fibers 424. Similarly, second gaps are the distances between an outer peripheral wall of the third bare optical fiber 423 and the fourth bare optical fiber 424 respectively with an inner peripheral wall of the corresponding first tube 52. The structural characteristics of the third bare optical fiber 423, the fourth bare optical fiber 425 and the correspond second tube 52 are similar with the structural characteristics of the first bare optical fiber 413, the second bare optical fiber 414 and the corresponding first tube 51. In some embodiments, as an outer diameter of the third bare optical fiber 423 and the fourth bare optical fiber 424 both are 0.25 mm, the inner diameter of the second tube 52 can be 0.3 mm, and the outer diameter of the second tube 52 can be 0.4 mm. The material of the first tube 51 and the second tube 52 can be selected from high-temperature resistant materials such as polypropylene (pp), high-density polyethylene (HDPE) and so on.

Referring to FIGS. 1C and 1D, the first limiting elements 61 and the second limiting elements 62 are located in the accommodating space 111. The first limiting elements 61 are arranged along the edge of the case 11 and are located on the right-side portion 113 of the case 11. Each of the first limiting elements 61 has an opening 611, and the first tubes 51 pass through the openings 611 of the corresponding first limiting elements 61, whereby the first tubes 51 are bonded via the first limiting elements 61. The second limiting elements 62 are arranged along the edge of the case 11 and are located on the left-side portion 112 of the case 11. Each of the second limiting elements 62 has an opening 621, and the second tubes 62 pass through the openings 621 of the corresponding second limiting elements 62, whereby the second tubes 52 are bonded via the second limiting elements 62.

Referring to FIG. 1D, the following is an assembly process to clarify the advantages of this embodiment, the components located in the left-side portion 112 and the right-side portion 113 of the case 11 are substantially symmetrical. Thus, the method of how the installer connects the first bare optical fiber 413 and the second bare optical fiber 414 with the corresponding first tube 51 to the two sets of first external signal transmission modules 21 and the two sets of first internal signal transmission modules 31 is shown hereinafter. Due to the limitation of the conventional assembly process technology, the optical fibers connected to the first inlet connector 411 and the first outlet connector 412 of the first optical signal processor 41 must be the bare optical fibers without any coating or cladding layer. And the conventional assembly process includes the following procedures. First, the first tubes 51 are individually sleeved on the first bare optical fibers 413 and the second bare optical fibers 414. Then, the first tube 51 and the first bare optical fiber 413 or the second bare optical fiber 414 located inside the first tube 51 are winded with maximum curvature. Under this winding operation, the optical losses caused via winding of the bare optical fiber can be reduced via preventing small radius of curvature. Second, after winding the first tube 51 and the respective first bare optical fiber 413 therein, the end of the individual first bare optical fibers 413 and the end of the individual second bare optical fibers 414 are terminated with the corresponding first external signal input channel 211, first external signal output channel 212, first internal signal input channel 311, or first internal signal output channel 312. Finally, each of the first bare fibers 413 disposed within the respective first tubes 51 and each of the second bare fiber 414 disposed within the respective first tubes 51 are disposed in the accommodating space 111 of the case 11.

It should be mentioned that the number of winding turns can be one, two, three or more. The size of the available accommodating space 111 decreases as the number of winding turns increases. When the number of winding turns increases, it becomes hard to arrange the first tubes 51 neatly in the accommodating space 111. In view of this, the present invention discloses that the first limiting elements 61 are arranged along the edge of the case 11 so that a longer wiring path is provided to ensure that each of the first bare optical fiber 413 and each of the second bare optical fiber 414 can be winded with a large radius of curvature in the case 11, even the first bare optical fiber 413 and/or the second bare optical fiber 414 having multiple coils. According to the arrangement of the first limiting elements 61, partial bare optical fibers are arranged in one side of the case 11. Hence, the damages of the bare optical fiber caused via large displacement and collision can be prevented.

The first tubes 51 are sorted out via the first limiting elements 61 without any external forces such as clamping or tightening, so that the bare fibers would still be able to transmit light. That is, light can pass through well because bare optical fibers are not deformed by external forces. The wire channel 425 has the same function as the first limiting elements 61, the first tubes 51 and the second tubes 52 can be sorted out together via the wire channel 425. The features and functions of the second limiting elements 62 are similar or identical to the first limiting elements 61.

According to the above-mentioned, the advantages of the optical signal processing device can be summarized as follows:

In the present invention, the first tube 51 is sleeved on the first bare optical fiber 413 and the second bare optical fiber 414, and the second tube 52 is sleeved on the third bare optical fiber 423 and the fourth bare optical fiber 424, respectively. Hence, not only the breakage via the external forces can be prevented and reduced during installation and/or transportation, but the delivery yield of the optical signal processing device can be greatly improved.

Meanwhile, in the present invention, due to the first bare optical fibers 413 and the second bare optical fibers 414 covered with the first tubes 51 are housed via the first limiting elements 61 or the wire channels 425, larger buffer spaces are provided for parts of the optical fibers 413 and the second bare optical fibers 414. That is, parts of the first bare optical fibers 413 and the second bare optical fibers 414 are not confined to one side of the case 11, so the probability of breaking as colliding with other components is greatly reduced.

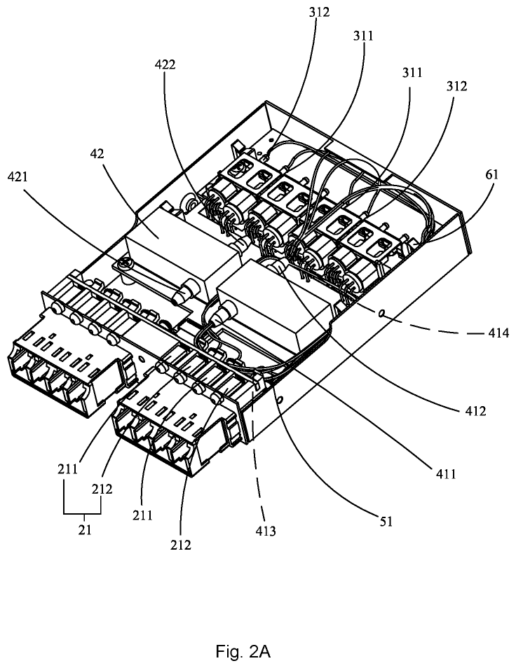

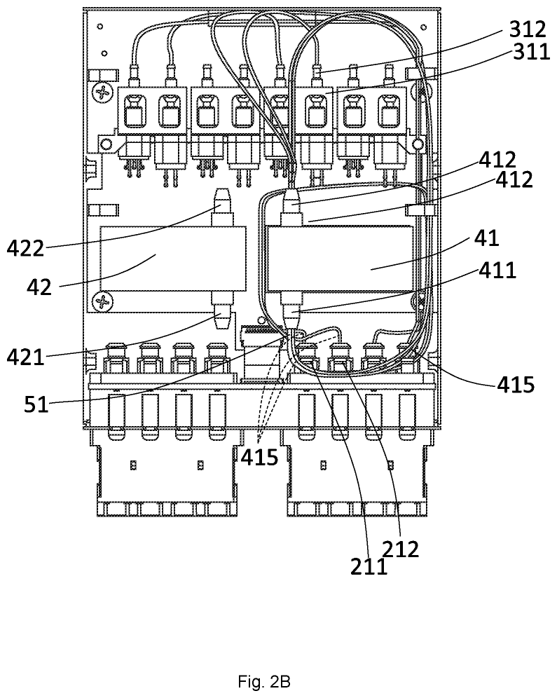

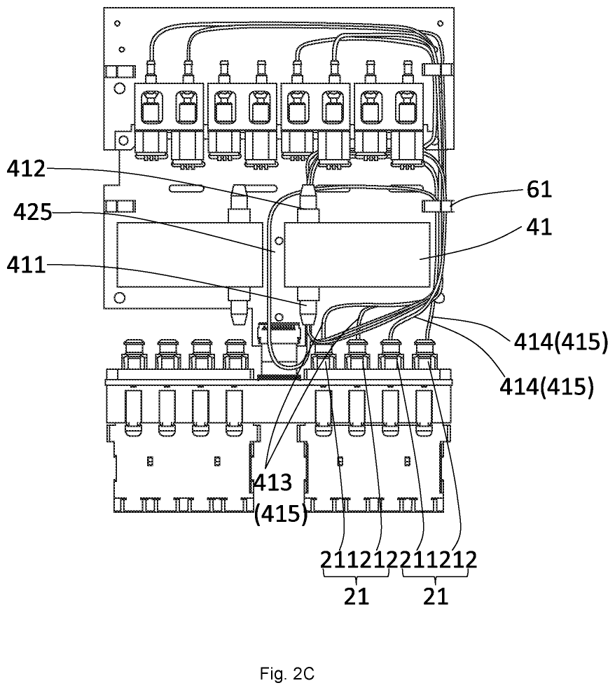

FIG. 2A is a schematic perspective first view of an alternative optical signal processing device, according to an example embodiment. FIG. 2B is a schematic perspective second view of the alternative optical signa process device of FIG. 2A, according to an example embodiment. Referring to FIGS. 2A and 2B, the main difference between the optical signal processing device of FIG. 1D and the alternative optical signal processing device of FIG. 2B is that the second optical signal processor 42 is not equipped with the third bare optical fibers (not shown) and the fourth bare optical fibers (not shown). That is, the first bare optical fiber 413 inside the first tubes 51 are connected to the first inlet connector 411, first external signal input channel 211 and first internal signal input channel 311. The second bare optical fiber 414 inside the first tubes 51 are connected to the second inlet connector 412, second external signal input channel 2121 and second internal signal input channel 312.

FIG. 2C is a view similar to FIG. 2B showing a plurality of connecting line segments are disposed away from a first inlet connector. Referring to FIG. 2C, in the front-rear portion, the first inlet connector 411 of the first optical signal processor 41 is located between the wire channel 425 and the two sets of first external signal transmission modules 21. In the left-right portion, the two sets of first external signal transmission modules 21 are located between the first inlet connector 411 of the first optical signal processor 41 and the first limiting elements 61. Each of the first bare optical fibers 413 and the second bare optical fibers 414 connected to the two sets of the first external signal transmission modules 21 has a connecting line segment 415 respectively. The wiring path of the connecting line segments 415 of FIG. 2C is different from the connecting lines segments 415 of FIG. 2B. As illustrated in the FIG. 2C, the connecting line segments 415 are disposed away from the first inlet connector 411. With respect to embodiment illustrated in FIG. 2B, that is the embodiment includes two of the connecting line segment 415 are routed away from the first inlet connector 411, and the other two are routed closer to the first inlet connector 411, the embodiment illustrated in FIG. 2C is more advantageous. The embodiment illustrated in FIG. 2C includes the connecting line segments 415 routed away from the first inlet connectors 411. The two of the connecting line segments 415 routed most away from the first inlet connector 411 pass through the first limiting elements 61 and are connected to the first internal signal transmission module 31. As for the two connecting line segments 415 routed closest to the first inlet connectors 411 pass through the first limiting elements 61 and the wire channel 425 and are connected to the first inlet connectors 411 in sequence. In this way, the routing paths of the connecting line segments 415 can be prevented from being bent significantly, so that the occurrence of light loss can be further reduced.

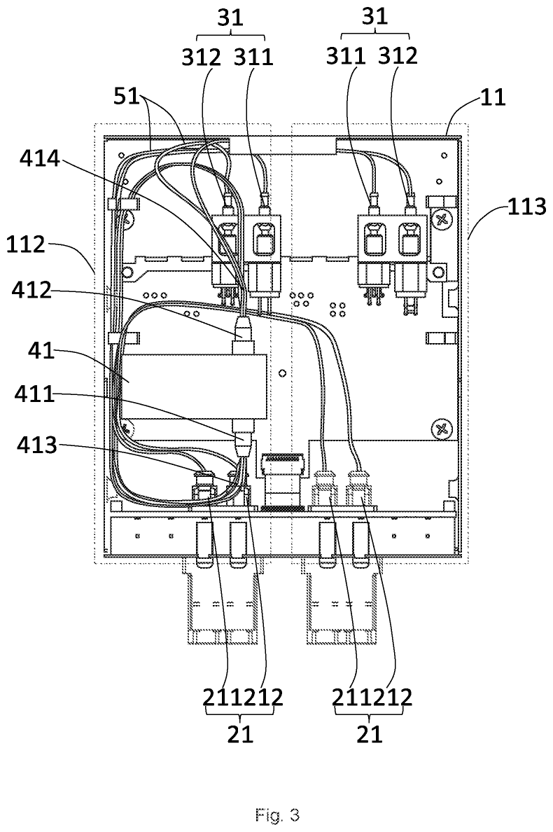

FIG. 3 is a schematic perspective first view of another alternative optical signal processing device, according to an example embodiment. Referring to FIG. 3, in an embodiment, the main difference between the optical signal processing device of FIG. 1D and another alternative optical signal processing device of FIG. 3 is that two sets of first external signal transmission modules 21, two sets of first internal signal transmission modules 31, a first optical signal processor 41, four first bare optical fibers 413 and four second bare optical fibers 414, and a plurality of first tubes 51 is merely provided. In some embodiments, the two sets of first external signal transmission modules 21 are located on the left-side portion 112 of the case 11 and the right-side portion 113 of the case 11, respectively. The two sets of first internal signal transmission modules 31 are located on the left-side portion 112 of the case 11 and the right-side portion 113 of the case 11, respectively. The four first bare optical fibers 413 are connected to the first inlet connector 411, two of the four of the first bare optical fibers 413 are connected to the firs external signal input channel 211 and the first external signal output channel 212, respectively. Meanwhile, four of the other two of the first bare optical fibers 413 are connected to the first internal signal input channel 311 and the internal signal output channel 312, respectively.

The four second bare optical fibers 414 are connected to the first outlet connector 412, two of the four of the second bare optical fibers 414 are connected to the firs external signal input channel 211 and the first external signal output channel 212, respectively. Meanwhile, four of the other two of the second bare optical fibers 414 are connected to the first internal signal input channel 311 and the internal signal output channel 312, respectively. Eight the first tubes 51 are individually sleeved on the individual first bare optical fibers 413 and the individual second bare optical fibers 414.

The presently disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those of ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. An optical signal processing device, comprising:
a case having an accommodating space;
two first external signal transmission modules partially located in the accommodating space, each of the first external signal transmission modules including a first external signal input channel and a first external signal output channel;
two first internal signal transmission modules located in the accommodating space, each of the first internal signal transmission modules including a first internal signal input channel and a first internal signal output channel;
a first optical signal processor located in the accommodating space, including a first inlet connector and a first outlet connector;
four first bare optical fibers and four second bare optical fibers, the first bare optical fibers connected to the first inlet connector, two of the first bare optical fibers connected to the first external signal input channels, and the other two of the first bare optical fibers connected to the first internal signal input channels, the second bare optical fibers connected to the first outlet connector, two of the second bare optical fibers connected to the first external signal output channels, and the other two of the second bare optical fibers connected to the first internal signal output channels;
a plurality of first tubes sleeved on the first bare optical fibers and the second bare optical fibers; and
a cover closing the accommodating space of the case.

2. The optical signal processing device of claim 1, further comprising a plurality of first limiting elements located inside the accommodating space, each of the first limiting elements having an opening, the first tubes passing through the openings of the corresponding first limiting elements, and the first tubes are located inside the first limiting elements.

3. The optical signal processing device of claim 2, wherein the first limiting elements are arranged along an edge of the case.

4. The optical signal processing device of claim 1, wherein a first gap is located between an outer peripheral wall of the first bare optical fiber and an inner peripheral wall of the corresponding first tube, and the first gap is located between the second bare optical fiber and an inner peripheral wall of the corresponding first tube.

5. The optical signal processing device of claim 4, wherein the ratio of the radius of each of the first bare optical fibers to the corresponding first gap in the radial direction is ranging from 5 to 1, and the ratio of the radius of each of the second bare optical fibers to the corresponding first gap in the radial direction is ranging from 5 to 1.

6. The optical signal processing device of claim 4, wherein an outer diameter of the first bare optical fiber is the same as the second bare optical fiber.

7. The optical signal processing device of claim 5, wherein the outer diameter of the first bare optical fiber is 0.25 mm, an inner diameter and an outer diameter of the first tube is 0.3 mm and 0.4 mm, respectively.

8. The optical signal processing device of claim 1, further comprising:
two second external signal transmission modules partially located in the accommodating space, each of the second external signal transmission modules including a second external signal input channel and a second external signal output channel;
two second internal signal transmission modules located in the accommodating space, each of the second internal signal transmission modules including a second internal signal input channel and a second internal signal output channel;
a second optical signal processor located in the accommodating space, including a second inlet connector and a second outlet connector;
four third bare optical fibers and four fourth bare optical fibers, the third bare optical fibers connected to the second inlet connector, two of the third bare optical fibers connected to the second external signal input channels, and the other two of the third bare optical fibers connected to the second internal signal input channels, the fourth bare optical fibers connected to the second outlet connector, two of the fourth bare optical fibers connected to the second external signal output channels, and the other two of the fourth bare optical fibers connected to the second internal signal output channels; and
a plurality of second tubes sleeved on the third bare optical fibers and the fourth bare optical fibers.

9. The optical signal processing device of claim 8, wherein the first optical signal processor, the second optical signal processor and a wire channel are correspondingly disposed in the case, the first optical signal processor and the second optical signal processor are adjacent to each other and the wire channel is adjacent to the first optical signal processor and the second optical signal processor, the wire channel is used to accommodate the corresponding first tubes and the second tubes.

10. The optical signal processing device of claim 9, wherein the first inlet connector of the first optical signal processor is between the wire channel and the first external signal transmission modules, each of the first bare optical fibers connected to the first external signal transmission modules has a connecting line segment and each of the second bare optical fibers connected to the first external signal transmission modules has a connecting line segment, and the connecting line segments are disposed away from the first inlet connector.

11. The optical signal processing device of claim 8, wherein two of the first external signal transmission modules are adjacent to two of the second external signal transmission modules in one side of the case, two of the first internal signal transmission modules are adjacent to two of the second internal signal transmission modules in the other side of the case, the first optical signal processor and the second optical signal processor are adjacent.

12. The optical signal processing device of claim 8, wherein two of the first external signal transmission modules and two of the first internal signal transmission modules are disposed opposite to each other, two of the second external signal transmission modules and two of the second internal signal transmission modules are disposed opposite to each other, the first optical signal processor is between the first external signal transmission module and the corresponding first internal signal transmission module, the second optical signal processor is between the second external signal transmission module and the corresponding second internal transmission module.

13. The optical signal processing device of claim 8, further comprising a plurality of second limiting elements located in the accommodating space, each of the second limiting elements having an opening, the second tubes passing through the openings of the corresponding second limiting elements, whereby the second tubes are collected inside the second limiting elements.

14. The optical signal processing device of claim 13, wherein a second gap is located between an outer peripheral wall of the third bare optical fiber and an inner peripheral wall of the corresponding second tube , and the second gap is located between the fourth bare optical fiber and an inner peripheral wall of the corresponding second tube.

15. The optical signal processing device of claim 14, wherein the ratio of the radius of each of the third bare optical fibers to the corresponding second gap in the radial direction is ranging from 5 to 1, and the ratio of the radius of each of the fourth bare optical fibers to the corresponding second gap in the radial direction is ranging from 5 to 1.

16. The optical signal processing device of claim 14, wherein an outer diameter of the third bare optical fiber is the same as the fourth bare optical fiber.

17. The optical signal processing device of claim 16, wherein the outer diameter of the third bare optical fiber is 0.25 mm, an inner diameter and an outer diameter of the second tube is 0.3 mm and 0.4 mm, respectively.

18. An optical signal processing device, comprising:
a case defining an accommodating space;
two first external signal transmission modules partially located in the accommodating space, each of the first external signal transmission modules including a first external signal input channel and a first external signal output channel;
two first internal signal transmission modules located in the accommodating space, each of the first internal signal transmission modules including a first internal signal input channel and a first internal signal output channel;
a first optical signal processor located in the accommodating space, including a first inlet connector and a first outlet connector;
four first bare optical fibers and four second bare optical fibers, the first bare optical fibers connected to the first inlet connector, two of the first bare optical fibers individually connected to the first external signal input channel and the first external signal output channel, and the other two of the first bare optical fibers individually connected to the first internal signal input channel and the first internal signal output channel, the second bare optical fibers connected to the first outlet connector, two of the second bare optical fibers individually connected to the first external signal input channel and the first external signal output channel, and the other two of the second bare optical fibers individually connected to the first internal signal input channel and the first internal signal output channel;
a plurality of first tubes sleeved on the first bare optical fibers and the second bare optical fibers; and
a cover closing the accommodating space of the case.

19. The optical signal processing device of claim 18, further comprising a plurality of first limiting elements located inside the accommodating space, each of the first limiting elements having an opening, the first tubes passing through the openings of the corresponding first limiting elements, and the first tubes are located inside the first limiting elements.

20. The optical signal processing device of claim 19, wherein the two sets of first external signal transmission modules are between the first inlet connector of the first optical signal processor and the first limiting elements, each of the first bare optical fibers has a connecting line segment and each of the second bare optical fibers has a connecting line segment, and the connecting line segments are disposed away from the first inlet connector.
